(19) United States
(12) Patent Application Publication
(10) Pub. No.: US 2026/0367433 A1
(43) Pub. Date: Nov. 19, 2026

(54) SWITCHABLE LIGHT FILTER, LIGHTING APPARATUS AND SCREEN

(71) Applicant: SIOPTICA GMBH, Jena (DE)

(72) Inventors: André HEBER, Weimar (DE); Markus KLIPPSTEIN, Jena (DE)

(73) Assignee: SIOPTICA GMBH, Jena (DE)

(21) Appl. No.: 19/138,658

(22) PCT Filed: Jul. 5, 2023
(86) PCT No.: PCT/EP2023/068614

§ 371 Date: Jun. 12, 2025

(30) Foreign Application Priority Data
May 15, 2023 (DE) 10 2023 112 757.8

(51) Int. Cl. G02F 1/13; G02F 1/133; G02F 1/1334; G02F 1/1347

(52) U.S. Cl. CPC G02F 1/1323; G02F 1/13306; G02F 1/1334; G02F 1/1347

(57) ABSTRACT

The invention relates to a switchable light filter, at least comprising a device for selectively influencing angle-dependent transmission of the switchable light filter for light incident on it, wherein the device for influencing angle-dependent transmission generate, at least at one time point at different positions on the switchable light filter for a selectable angle which is the same at each of said different positions on the switchable light filter, at least three different values of the transmission for at least one direction of the hemisphere, namely a minimum, an average and a maximum value of the transmission. The invention further discloses switchable lighting devices and switchable screens.

### TECHNICAL FIELD

In the last few years, significant advances have been made in widening the viewing angle of liquid crystal display (LCD). However, there are often situations in which the very wide viewing range of screens may be disadvantageous. Increasingly, information on mobile devices such as notebooks and tablets becomes available, such as bank data or other personal details and sensitive data. Accordingly, people need control over who can see this sensitive data, and they must be allowed to select between a public mode with a wide viewing angle to share information on their display with others, e.g., viewing vacation photos or for advertising purposes and a private mode with a narrow viewing angle when handling image data privately.

A similar problem arises in automotive engineering. When the engine is running, the driver must not be distracted by image contents, such as digital entertainment programs, while the passenger may still want to view such contents during the journey. Consequently, there is a need for such a screen that is switchable between the corresponding display modes.

Additional films based on micro-louvers have already been used in mobile displays to achieve visual privacy protection. However, these films are not be switchable, and they always have to be placed by hand first and then removed again. They also have to be taken separately from the display when they are not needed at the moment. Further, a significant disadvantage of the use of such louver films is connected with the associated light losses.

### BACKGROUND

U.S. Pat. No. 6,765,550 B2 describes such an anti-peeping protection using micro-louvers. The largest disadvantages are the mechanical removal/attachment of the filter and the light loss in the privacy mode.

U.S. Pat. No. 5,993,940 A details a film with microscopic prismatic stripes uniformly arranged to achieve privacy mode (i.e., a limited viewing angle range). Development and manufacturing are technically complex.

WO2012/033583A1 achieves switching between public and private views by controlling liquid crystals between so-called “chromonic” layers, thereby causing light loss and significant technical complexity.

US2012/0235891A1 describes a very complex backlight—a background lighting—in a screen. According to FIGS. 1 and 15, not only several light guides are used there, but also complex optical elements such as micro-lens elements 40 and prism structures 50, which transform the light from the backlight into the lighting in front of it. This is expensive and technically complex to implement and also causes light loss. According to the variant shown in FIG. 17 of the US2012/0235891A1, both light sources 4R and 18 produce light with a narrow lighting angle, wherein the light from the rear light source 18 is first converted into light with a large lighting angle. This complex conversion strongly decreases the brightness, as already noted above.

In US 2013/0308185 A1, a special stepped light guide is described, which emits light in different directions on a large area, depending on the direction from which it is illuminated from one of its narrow sides. In combination with a transmissive display device, such as an LC display, a switchable screen between free and limited viewing modes can thus be achieved. Moreover, a disadvantage here is that the limited viewing effect can be implemented either only for left/right or for up/down, but not simultaneously for left/right/up/down, as is necessary for certain payment transactions. In addition, even in the limited viewing mode, residual light is still visible from blocked viewing angles.

WO 2015/121398 A1 of the applicant describes a screen with two operation modes, in which scattering particles in the volume of the corresponding light guide are used for switching between the operation modes. However, the chosen scattering particles are made of a polymer and typically have the disadvantage that light is coupled out from both large surfaces. As a result, about half of the useful light is emitted in the wrong direction, namely towards the backlight, and due to the structure, it cannot be sufficiently recycled there. Moreover, the scattering particles distributed in the volume of the light guide, especially at higher concentrations, can potentially cause scattering effects that reduce the anti-peeping effect in the protected operation mode.

The approach of the “electrically controlled birefringence (ECB)” technology is based on the idea of using the switchable liquid crystals of an additionally applied LC panel to “filter” all light rays that do not exit the image-generating layer at a specific emission angle. The disadvantages of this technology include high additional energy, cost requirements, and the difficult-to-adjust +/−40° sweet spot, i.e., the optimal viewing position. The absorption level of the LC structures is also insufficient, as the attenuation of light intensity increases again for viewing angles greater than the sweet spot, so that light intensity for viewing angles greater than +/−40° is up to 3% of the maximum light intensity.

The aforementioned methods and arrangements generally share the disadvantage that they significantly reduce the brightness of the base display screen, require a complex and expensive optical element for mode switching, reduce the resolution in the freely viewable public mode, and/or exhibit visual artifacts in very high-resolution displays. Moreover, especially when partial switching between modes is possible, visible edges between areas in different modes are unpleasantly visible.

### SUMMARY

The object of the present disclosure is to describe a light filter in which the light incident in it is transmitted at different positions on the light filter or the screen having such a light filter, or partially or (almost) completely absorbed. To avoid visible edges during partial switching, at least three operation modes must be provided. Specifically, the transmission behavior should be switchable for defined angles or directions. In addition, a corresponding screen or a lighting device may be described, whose angle-dependent luminance distribution can be locally changed, and visible edges between areas operating in different modes may also be avoided.

The present disclosure provides a switchable light filter. The switchable light filter comprises a device for selectively influencing an angle-dependent transmittance of the switchable light filter for light incident thereon, wherein the device for influencing the angle-dependent transmittance is configured to generate, at least at a time point at different positions on the switchable light filter for a selectable angle that is same at each of the different positions on the switchable light filter, at least three mutually different values, which are a minimal value, an intermediate value, and a maximal value of the transmittance, of the transmittance for at least one direction of a hemisphere. This need not apply to multiple or all possible angles, but must hold for at least one selectable same angle. The term ‘intermediate value’ is merely a designation, and it need not exactly refer to the mean of the minimum and maximum values, though it may. In preferred implementations, at least five, eight, or even more transmission values different from each other are generated at corresponding five, eight, or more positions, respectively.

For using the light filter according to the present disclosure, a device for generating linear polarized light is advantageously included. Exemplarily, this may comprise a liquid crystal panel with polarization filter, or when using another image/light source, a polarization filter.

In a first embodiment, the device for influencing the angle-dependent transmittance of the switchable light filter comprises at least a guest-host liquid crystal arrangement having liquid crystal molecules or polymer dispersed liquid crystal (PDLC) having liquid crystal molecules, an orientations of the liquid crystal molecules determines the angle-dependent transmittance of the switchable light filter, and the orientations of the liquid crystal molecules are different at the different positions on the switchable light filter.

In a second embodiment, the device for influencing the angle-dependent transmittance of the switchable light filter is integrated in a dual-cell or multi-cell configuration, the orientations of the liquid crystal molecules in the dual-cell or multi-cell configuration which are responsible for the variable angle-dependent transmittance are different at the different positions on the switchable light filter.

Further, in a third embodiment, the switchable light filter comprises:
a first optical element comprising
   a plurality of light-absorbing transition dipole moments arranged in a layer having a thickness of at least 0.2 micrometers,
   wherein in at least a first state, the plurality of light-absorbing transition dipole moments are aligned with a tolerance of maximally 20° parallel to a first preferred direction that is selectable for the first optical element, or fluctuate around the first preferred direction, the first preferred direction being set at a predefined angle α relative to a perpendicular bisector of the first optical element, and the angle α being measured in a selectable first plane including the perpendicular bisector,
   so that light incident on the first optical element and having an incidence direction and a polarization state is transmitted therethrough or at least partially absorbed, according to the incidence direction relative to the first optical element and the polarization state;
a device for selectively applying at least one of a first electric field EF1, a second electric field EF2, or a third electric field EF3, wherein the first electric field EF1, the second electric field EF2, and the third electric field EF3 may be each selectable to different positions on the switchable light filter in different manners;
a liquid crystal layer arranged behind or in front of the first optical element in a viewing direction, wherein the first electric field EF1, the second electric field EF2, and the third electric field EF3 each act on the liquid crystal layer, so that the liquid crystal layer influences, based on the electric field, the polarization state of light passing through it;
a first linear polarizer X, which is disposed in front of the liquid crystal layer in the viewing direction under a condition that the liquid crystal layer is arranged in front of the first optical element in the viewing direction,
so that the transmission property of the switchable light filter 5 varies at each of the positions for an operation mode B1 in which the first electric field EF1 is applied, an operation mode B2 in which the second electric field EF2 is applied, and at least an operation mode B3 in which the third electric field EF3 is applied, the respective relative transmittances at each of the positions in the operation modes B1, B2, and B3 within a selectable tolerance are described by a first transmittance T_{B1}(ß) for the operation mode B1, a second transmittance T_{B2}(ß) for the operation mode B2, and a third transmittance T_{B3}(ß) for the operation mode B3, and the first transmittance, the second transmittance, and the third transmittance are each dependent on an angle ß, and normalized, so that T_{B1}(α)=1, T_{B2}(α)=1, and T_{B3}(α)=1 hold for the value of the transmittances at the predefined angle α, wherein
   under a condition that light is incident on the first optical element at the angle ß with ß=α−40° or ß=α+40°, at positions in the operation mode B1 in which the first electric field EF1 is applied, an s-polarized component of the light is transmitted with at least a normalized first transmittance value T_{B1}(ß)≥0.25,
   under the condition that light is incident on the first optical element at the angle ß with ß=α−40° or ß=α+40°, at positions in the operation mode B2 in which the second electric field EF2 is applied, a p-polarized component of the light is transmitted with at least a normalized second transmittance value T_{B2}(ß)≤0.2, and
   under the condition that light is incident on the first optical element at the angle ß with ß=α−40° or ß=α+40°, at positions in the operation mode B3 in which the third electric field EF3 is applied, the light is transmitted with a normalized third transmittance value T_{B2}(ß)<T_{B3}(ß)<T_{B1}(ß).

S-polarized light refers to light whose electric field is oriented perpendicular to an incidence plane on a medium, and p-polarized light refers to light that is oriented parallel to incidence plane. The incidence plane is spanned by the interface normal of the medium and incidence direction.

Further, in a fourth embodiment, the switchable light filter comprises:
a first optical element comprising
   a plurality of light-absorbing transition dipole moments arranged in a layer having a thickness of at least 0.2 micrometers,
   wherein in at least a first state, the plurality of light-absorbing transition dipole moments are aligned with a tolerance of maximally 20° parallel to a first preferred direction that is selectable for the first optical element, or fluctuate around the first preferred direction, the first preferred direction being set at a predefined angle α relative to a perpendicular bisector of the first optical element, and the angle α being measured in a selectable first plane including the perpendicular bisector,
   so that light incident on the first optical element is transmitted therethrough or at least partially absorbed, according to the incidence direction thereof relative to the first optical element and a polarization state thereof;
a liquid crystal layer having liquid crystal molecules and arranged behind or in front of the first optical element in a viewing direction, orientations of the liquid crystal molecules being pixel-by-pixel influenced by local controllable electric fields, so that the polarization state of the light passing through the first optical element is influenced according to the respective pixel-by-pixel selectable orientations of the liquid crystal molecules,
wherein the local controllable electric fields are controlled by a drive circuit, and the drive circuit is controlled by a plurality of digital signals (which encode at least a minimum transmittance, a maximum transmittance, and an intermediate transmittance), which are provided correspondingly for pixels each, and at least one of a maximal digital signal, a minimal digital signal, or an intermediate digital signal between the maximal and the minimal digital signals is selected at least at a time point;
a first linear polarizer X arranged in front of the liquid crystal layer in the viewing direction under a condition that the liquid crystal layer is arranged in the viewing direction in front of the first optical element,
so that at the time point, under a condition that the drive circuit is controlled by at least three digital signals, at least three mutually different values, which are the minimal value, the intermediate value, and the maximal value of the transmittance, are generated at different positions on the switchable light filter for a selectable angle that is the same for all the different positions on the switchable light filter.

Exemplarily, corresponding digital signals can correspond to one of the 256 gray levels stored in a bitmap file. Optionally, they can be dynamically adjusted.

Preferably, in one or more embodiments, at least three mutually different values of the transmittance are generated, for the angle that is the same, at the different positions on the switchable light filter respectively, and the different positions are preferably directly adjacent. That is, the transmission values for a fixed angle decrease or increase along a selectable straight line on the surface of the switchable light filter from maximum to minimum values or vice versa. Thus, a relatively smooth transition of the transmission values from minimum to maximum or vice versa is achieved, because at least the intermediate value of the transmission is spatially lay therebetween.

As described above, more than three transmission values (e.g., five, eight, or more than eight) are desirable to make the aforementioned transition continuous and visually smooth.

In the embodiments described above, the same means-and-effect relationships apply: a location of the maximum transmittance does not immediately follow a local location of the minimum transmittance for a selectable angle, which usually corresponds to the angle α, but can also be chosen differently (for example, when the angle is 45° in a horizontal direction from a viewer's perspective, this location on the switchable light filter is in a privacy mode), but follows at least one location representing the average value of the transmittance under the given angle, or several intermediate values of the transmittance as described.

The third and fourth embodiments may be reformulated for some implementations as follows:

Preferably, polarized light is incident on a liquid crystal layer and a first optical element, in which dichroic dyes are arranged either parallel or perpendicular to a substrate surface. Electrodes E1 and E2 enable the generation of the spatially varied first and second electric fields EF1 and EF2, whereby the transmission properties can be selected. Static and/or dynamic superposition of the first electric field EF1 and the second electric field EF2 enables the generation of defined average values of the transmittance to minimize the perceptibility of edges between the locations with the respective first and second electric fields.

Generally, “positions” refers to two-dimensional positions, which, if present, on the first optical element and the switchable light filter each indicate the same X-and Y-coordinates on the surface. Therefore, the term “position” can be used with congruent meaning for the optical element and the switchable light filter.

If present, the first optical element and/or the liquid crystal layer can be divided into multiple separate switchable segments, thereby enabling local switchability between the respective possible operation states.

In special embodiments, the switchable light filter can comprise at least two first optical elements, and optionally, a retardation plate is arranged between at least two first optical elements.

The present application further includes a lighting device for a screen, which is adapted to operate in at least two operation modes comprising an operation mode B1 for a free view mode and an operation mode B2 for a limited view mode. In the operation mode B2, light is emitted within a viewing angle range that is limited for an observer compared to the free view mode. The lighting device comprises: a backlight extended in a flat manner and configured to emit light and to optionally directly be luminous; and a switchable light filter arranged in front of the backlight in the viewing direction, as described above.

In addition, the present disclosure further comprises a screen, which is adapted to operate in at least two operation modes comprising an operation mode B1 for a free view mode and an operation mode B2 for a limited view mode. In the operation mode B2, light is emitted within a viewing angle range that is limited for an observer compared to the free view mode. The screen comprises:
an above-described lighting device;
under a condition that a first linear polarization filter is not provided in the switchable light filter of the lighting device, a second linear polarization filter arranged in front of the backlight in the viewing direction, whereby light, which emits from the backlight and passes through the second linear polarization filter, is limited in its propagation direction; and
a transmissive display device arranged in front of the switchable light filter in the viewing direction,
wherein in the operation mode B2, the second electric field EF2 is applied, and wherein in the operation mode B1, the first electric field EF1 is applied.

The first linear polarization filter or the second linear polarization filter can be arranged in the transmissive display device or be a part of it.

In addition, the present disclosure provides a screen. The screen comprises: a display device; and an above-described switchable light filter arranged behind or in front of the display device in the viewing direction, as described above.

It is possible that the switchable light filter is subsequently attached by a user and/or reversibly mounted on the display device.

In addition, the present disclosure further comprises a screen, which is adapted to operate in at least two operation modes comprising an operation mode B1 for a free view mode and an operation mode B2 for a limited view model. In the operation mode B2, light is emitted within a viewing angle range that is limited for an observer compared to the free view mode. The screen comprises: a transmissive display device, preferably a LC panel; a backlight arranged in a viewing direction behind the transmissive display device, wherein the backlight has an asymmetric luminance distribution, and preferably the asymmetry relative to the viewer's perspective exists in the horizontal direction (i.e., parallel to an imaginary line between the viewer's eyes); and a switchable light filter arranged behind or in front of the display device in the viewing direction, as described above.

In addition, the present disclosure further comprises a lighting device for a screen, which is adapted to operate in at least two operation modes comprising an operation mode B1 for a free view mode and an operation mode B2 for a limited view mode. In the operation mode B2, light is emitted within a viewing angle range that is limited compared to the free view mode. The lighting device comprises:
a backlight extended in a flat manner and configured to emit light within a limited viewing angle range and to optionally directly be luminous;
a plate-shaped light guide, disposed in front of the backlight in a viewing direction, wherein the plate-shaped light guide has decoupling elements on at least one of large surfaces and/or inside a volume of the plate-shaped light guide;
lighting components arranged laterally on at least a narrow side of the light guide;
optionally, a linear polarization filter; and
an above-described switchable light filter arranged in front of the backlight in the viewing direction,
wherein in the operation mode B2, the backlight is turned on, and the lighting components are turned off, and wherein in the operation mode B1, at least the lighting components are turned on.

Alternatively, the lighting device for a screen can be adapted to operate in at least two operation modes comprising an operation mode B1 for a free view mode and an operation mode B2 for a limited view mode. In the operation mode B2, light is emitted within a viewing angle range that is limited compared to the free view mode. The lighting device comprises:
a backlight extended in a flat manner and configured to emit light within a non-limited viewing angle range and to optionally directly be luminous;
a plate-shaped light guide, disposed in front of the backlight in a viewing direction, wherein the plate-shaped light guide has decoupling elements on at least one of large surfaces and/or inside a volume of the plate-shaped light guide, wherein the decoupling elements primarily extract laterally coupled light in at least one narrow side of the light guide within a limited viewing angle range;
lighting components arranged laterally on at least a narrow side of the light guide;
optionally, a linear polarization filter; and
an above-described switchable light filter arranged in front of the backlight in the viewing direction,
wherein in the operation mode B2, the backlight is turned off, and the lighting components are turned on, and wherein in the operation mode B1, at least the backlight is turned on.

The same means-and-effect relationships apply to a switchable lighting device, which can be adapted to operate in at least two operation modes comprising an operation mode B1 for a free view mode and an operation mode B2 for a limited view mode. In the operation mode B2, light is emitted within a viewing angle range that is limited compared to the free view mode. The switchable lighting device comprises:
a backlight extended in a flat manner, and configured to emit a first alternate light within a limited viewing angle range and a second alternate light within a non-limited viewing angle range and to optionally directly be luminous;
a plate-shaped light guide, disposed in front of the backlight in a viewing direction, wherein the plate-shaped light guide has decoupling elements on at least one of large surfaces and/or inside a volume of the plate-shaped light guide; and
lighting components arranged laterally on at least a narrow side of the light guide,
wherein in a first alternative, in the operation mode B2, the backlight is turned on and the light mean is turned off, and in the operation mode B1, at least the light mean is turned on; wherein in a second alternative, in the operation mode B2, the backlight is turned off and the light mean is turned on, and in the operation mode B1, at least the backlight is turned on,
wherein, under a condition that one or both of the backlight and the light guide emit light, the backlight and/or the light guide generates at least at a time point at different positions on the backlight and/or the light guide for a selectable angle that is same at each of the different positions, at least three mutually different brightness, which are a minimal value, an intermediate value, and a maximal value of the brightness.

The design suggestions provided above also apply here according to the gist. In particular, it is preferred that at least three mutually different values of the brightness are generated for the angle that is same at each of the different positions on the backlight and/or the light guide, and the different positions are (preferably directly) adjacent.

Finally, by applying the same means-and-effect relationships, the present disclosure includes a switchable display screen, which at least comprises:
a display device; and
a device for influencing an angle-dependent brightness of the switchable screen,
wherein the device for influencing the angle-dependent brightness is configured to generate, at least at a time point at different positions on the switchable screen for a selectable angle that is same at each of the different positions on the switchable screen, at least three mutually different values of the brightness, which are a minimal value, an intermediate value, and a maximal value of the brightness.

To achieve this device for influencing an angle-dependent brightness of the switchable screen, controllable and angle-dependent absorption, reflection, contrast, or scattering may be used.

A light filter, a lighting device, or a screen as described above is advantageously used in a mobile device, a land/air/water vehicle, in a payment terminal, or in an access system. The switching between the aforementioned operation modes can be used to protect sensitive data, i.e., to make them perceptible only to a viewer, or to display image content for multiple viewers simultaneously.

The functionality of the present disclosure is essentially maintained if the described parameters are varied within certain limits.

It is understood that the features mentioned above and those described hereinafter may be used not only in the specified combinations, but also in other combinations or in isolation, without departing from the scope of the present disclosure.

### BRIEF DESCRIPTION OF THE DRAWINGS

The present disclosure will be described in more detail below according to exemplary embodiments with reference to the accompanying drawings, which disclose features essential for the present disclosure. These exemplary embodiments are for illustration purposes only and are not to be interpreted as being limiting. For example, a description of an exemplary embodiment with a plurality of elements or components is not to be interpreted to the effect that all of these elements or components are necessary for the implementation. In contrast, other exemplary embodiments can also include alternative elements and components, fewer elements or components, or additional elements or components. Elements or components of different exemplary embodiments can be combined with one another, unless otherwise stated. Modifications and variations, which are described for one of the exemplary embodiments, can also be applied for other exemplary embodiments. To avoid repetitions, identical or corresponding elements in different figures are identified with identical reference numerals and are not described repeatedly, in which:

FIG. 1A shows a schematic view for an operation principle of an exemplary switchable light filter with locally different transmittances;

FIG. 1B shows a schematic view for an operation principle of an exemplary switchable light filter in three different operation modes B1, B2, and B3;

FIG. 2 shows a schematic view of an exemplary arrangement of a switchable light filter in a first design;

FIG. 3 shows an exemplary normalized transmittance graph (schematic view based on a measurement) over the horizontal angle range for a switchable light filter in the first (local) operation mode B1 for a maximum transmittance T1;

FIG. 4 shows an exemplary normalized transmittance graph (schematic view based on a measurement) over the horizontal angle range for a switchable light filter in the second (local) operation mode B2 for a minimum transmittance T2;

FIG. 5 shows an exemplary normalized transmittance graph (schematic view based on a measurement) over the horizontal angle range for a switchable light filter in the third (local) operation mode B3 for a first intermediate transmittance T3;

FIG. 6 shows an exemplary normalized transmittance graph (schematic view based on a measurement) over the horizontal angle range for a switchable light filter in the third (local) operation mode B3 for a second intermediate transmittance T3;

FIG. 7 shows an exemplary normalized transmittance graph (schematic view based on a measurement) over the horizontal angle range for a switchable light filter in the third (local) operation mode B3 for a third intermediate transmittance T3;

FIG. 8 shows a schematic view for digital signals corresponding to one of the 256 gray levels in the prior art;

FIG. 9A shows another schematic view for digital signals corresponding to one of the 256 gray levels, wherein a vertical edge between areas of different operation modes is made less visible;

FIG. 9B shows another schematic view for digital signals corresponding to one of the 256 gray levels, wherein a horizontal edge between areas of different operation modes is made less visible; and

FIG. 10 shows still another schematic view for digital signals corresponding to one of the 256 gray levels, wherein the transition between areas of different operation modes is made less visible radially.

### REFERENCE NUMERALS

1, first optical element; 3, liquid crystal layer; 5, switchable light filter; P, p-polarized light; S, s-polarized light; T1, maximum transmittance; T2, minimum transmittance; T3, intermediate transmittance; X, polarization filter.

### DETAILED DESCRIPTION

The drawings are not to scale and merely illustrate the principles.

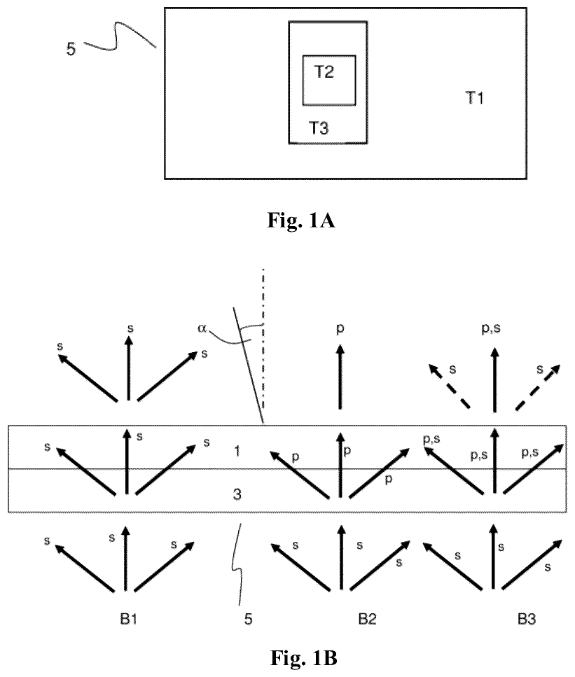

FIG. 1A shows a schematic view for an operation principle of an exemplary switchable light filter 5 with locally different transmittances T1, T2, and T3. Here, areas of the minimum transmittance T2 are completely surrounded by areas of the intermediate transmittance T3, which are completely surrounded by areas of the maximum transmittance T1. Other designs are possible.

Such an exemplary switchable light filter 5 at least comprises a device for selectively influencing an angle-dependent transmittance of the switchable light filter 5 for light incident thereon, wherein the device for influencing the angle-dependent transmittance is configured to generate, at least at a time point at different positions on the switchable light filter 5 for a selectable angle that is same at each of the different positions on the switchable light filter 5, at least three mutually different values, which are a minimal value T2, an intermediate value T3, and a maximal value T1 of the transmittance, of the transmittance for at least one direction of a hemisphere. This need not apply to multiple or all possible angles, but must hold for at least one selectable same angle. The term ‘intermediate value’ is merely a designation, and it need not refer exactly to the mean of the minimum and maximum values, though it may. In preferred implementations, at least five, eight, or even more transmission values different from each other are generated at corresponding five, eight, or more positions respectively.

For using the light filter according to the present disclosure, a device for generating linear polarized light is advantageously included. As an example, this may comprise a liquid crystal panel with polarization filter, or when using another image/light source, a polarization filter.

FIG. 1B shows a schematic view for an operation principle of an exemplary switchable light filter 5 in three different operation modes B1, B2, and B3. This exemplary light filter 5 comprises:
a. a first optical element 1 comprising:
   i. a plurality of light-absorbing transition dipole moments arranged in a layer having a thickness of at least 0.2 micrometers,
   ii. wherein the light-absorbing transition dipole moments are aligned with a tolerance of maximally 20° parallel to a first preferred direction that is selectable for the first optical element 1, or fluctuate around the first preferred direction, the first preferred direction is set at a predefined angle α relative to a perpendicular bisector of the first optical element 1, and the angle α is measured in a selectable first plane having the perpendicular bisector,
   iii. so that light incident in the first optical element 1 is transmitted therethrough or at least partially absorbed, according to an incidence direction thereof relative to the first optical element 1 and a polarization state thereof;
b. a device for selectively applying at least one of a first electric field EF1, a second electric field EF2, or a third electric field EF3, wherein the first electric field EF1, the second electric field EF2, and the third electric field EF3 may be each selectable to be applied to different positions on the switchable light filter 5 in different manners;
c. a liquid crystal layer 3 arranged behind or in front of the first optical element 1 in a viewing direction, wherein the first electric field EF1, the second electric field EF2, and the third electric field EF3 each act on the liquid crystal layer, so that the liquid crystal layer influences the polarization state of light passing through it;
d. a first linear polarization filter X arranged in front of the liquid crystal layer 3 in the viewing direction under a condition that the liquid crystal layer 3 is arranged in the viewing direction in front of the first optical element 1,
e. so that the transmission property of the switchable light filter 5 varies at each of the positions for an operation mode B1 in which the first electric field EF1 is applied, an operation mode B2 in which the second electric field EF2 is applied, and at least an operation mode B3 in which the third electric field EF3 is applied, the respective relative transmittances at each of the positions in the operation modes B1, B2, and B3 within a selectable tolerance is described by a first transmittance TB1(ß) for the operation mode B1, a second transmittance TB2(ß) for the operation mode B2, and a third transmittance TB3(ß) for the operation mode B3, and the first transmittance, the second transmittance, and the third transmittance are each dependent on an angle ß, and normalized, so that TB1(α)=1, TB2(α)=1, and TB3(α)=1 hold for the values of the transmittances at the predefined angle α,
f. wherein
   i. under a condition that light is incident on the first optical element 1 at the angle ß with ß=α−40° or ß=α+40°, at positions in the operation mode B1 in which the first electric field EF1 is applied, an s-polarized component of the light is transmitted with at least a normalized first transmittance value T_{B1}(ß)≥0.25,
   ii. under the condition that light is incident on the first optical element 1 at the angle ß with ß=α−40° or ß=α+40°, at positions in the operation mode B2 in which the second electric field EF2 is applied, a p-polarized component of the light is transmitted with at least a normalized second transmittance value T_{B2}(ß)≤0.2, and
   iii. under the condition that light is incident on the first optical element 1 at the angle ß with ß=α−40° or ß=α+40°, at positions in the operation mode B3 in which the third electric field EF3 is applied, the light is transmitted with a normalized third transmittance value T_{B2}(ß)<T_{B3}(ß)<T_{B1}(ß).

The letters “s” and “p” indicate whether the light is s-polarized or p-polarized, respectively. In the local operation mode B3 with the intermediate transmittance T3, only a part the light is transmitted to the side, i.e., the s-polarized light, while the p-polarized light is mostly absorbed by the first optical element 1, when |ß−α|>30°. The values for T_{B2}(ß), T_{B3}(ß), and T_{B1}(ß) can be correlated with or set equal to the transmittances T2, T3, and T1 for one (or more) selected fixed angle ß respectively.

For the normalization of the transmittances T_{B1}(α)=1 and T_{B2}(α)=1, the following should be noted: the angles α and ß are measured in the same predefined plane. It is fundamentally possible that T_{B1}(α)>1 and/or T_{B2}(α)>1 hold for the angle ß≠α. However, in many cases, T_{B1}(α)<1 and/or T_{B2}(α)<1 hold for the angle ß≠α.

The angle α is showed in FIG. 1 with a value greater than 0° for better clarity. However, for all subsequent considerations, α=0° should fundamentally be applied. The values of α≠0° allow for the tilting of the preferred transmittance direction, i.e., the maximum transmittance of the switchable light filter 5.

It is advantageous that the transition dipole moments are formed as one or more dichroic dyes, which are mixed with the liquid crystals in a guest-host arrangement. For permanent transition dipole moments, the liquid crystals can be fixed through a curing process. The dichroic dye molecules generally align parallel to the liquid crystal molecules.

Exemplarily, the first preferred direction can form an angle between 0° and 45° with a surface normal of the first optical element 1. Furthermore, it is possible that the first preferred direction varies across the surface of the first optical element 1. In the sense of the present disclosure, the average weighted preferred direction applies.

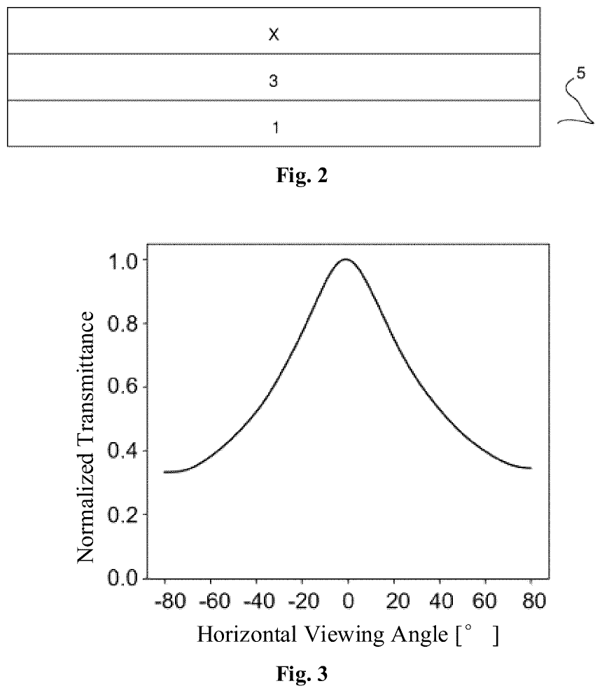

FIG. 2 shows a schematic view of an exemplary arrangement of a switchable light filter 5 in a first design. Here, the liquid crystal layer 3 is arranged in the viewing direction (from above) in front of the first optical element 1. This first embodiment also includes a first linear polarization filter X arranged in the viewing direction in front of the liquid crystal layer 3, whose preferred polarization transmission direction is preferably aligned parallel to an edge of the optical element 1, preferably the lower edge.

In addition, FIG. 3 shows an exemplary normalized transmittance graph (schematic view based on a measurement) over the horizontal angle range for a switchable light filter 5 in the second (local) operation mode B1 for a minimum transmittance T1. For a selectable angle, a (normalized) maximum transmittance T1 can be chosen here.

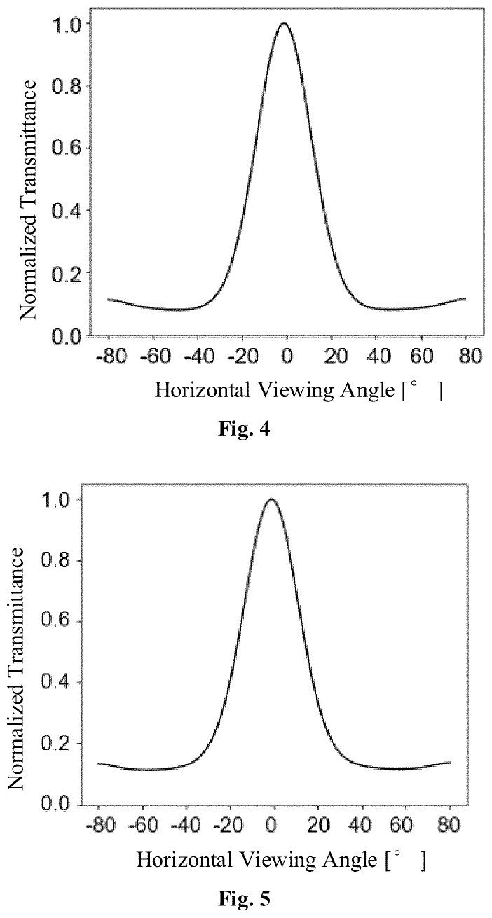

Further, FIG. 4 shows an exemplary normalized transmittance graph (schematic view based on a measurement) over the horizontal angle range for a switchable light filter 5 in the second (local) operation mode B2 for a minimum transmittance T2. For a selectable angle, a (normalized) minimum transmittance T2 can be chosen here.

FIG. 5 shows an exemplary normalized transmittance graph (schematic view based on a measurement) over the horizontal angle range for a switchable light filter 5 in the third (local) operation mode B3 for a first intermediate transmittance T3. For a selectable angle, a (normalized) first intermediate transmittance T3 can be chosen here.

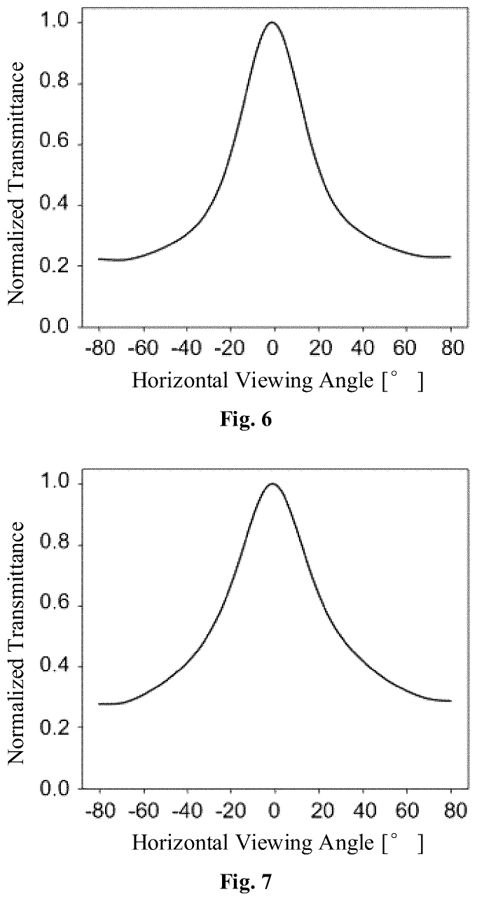

Furthermore, FIG. 6 shows an exemplary normalized transmittance graph (schematic view based on a measurement) over the horizontal angle range for a switchable light filter 5 in the third (local) operation mode B3 for a second intermediate transmittance T3. For a selectable angle, a (normalized) second intermediate transmittance T3 can be chosen here.

FIG. 7 shows an exemplary normalized transmittance graph (schematic view based on a measurement) over the horizontal angle range for a switchable light filter 5 in the third (local) operation mode B3 for a third intermediate transmittance T3. For a selectable angle, a (normalized) third intermediate transmittance T3 can be chosen here.

Exemplarily, the graphs described above shown in FIGS. 3 to 7 can be practically generated in the aforementioned third embodiment referring to FIGS. 1B and 2.

Furthermore, in a fourth embodiment, referring to FIGS. 1B and 2, the switchable light filter 5 comprises:
a first optical element 1, comprising
   a plurality of light-absorbing transition dipole moments arranged in a layer having a thickness of at least 0.2 micrometers,
   wherein in at least a first state, the plurality of light-absorbing transition dipole moments are aligned with a tolerance of maximally 20° parallel to a first preferred direction that is selectable for the first optical element 1, or fluctuate around the first preferred direction, the first preferred direction being set at a predefined angle α relative to a perpendicular bisector of the first optical element 1, and the angle α is measured in a selectable first plane having the perpendicular bisector,
   so that light incident on the first optical element 1 is transmitted according to an incidence direction thereof relative to the first optical element 1 and a polarization state thereof, or at least partially absorbed;
a liquid crystal layer 3 having liquid crystal molecules and arranged behind or in front of the first optical element 1 in a viewing direction, orientations of the liquid crystal molecules being pixel-by-pixel influenced by local controllable electric fields in the orientations thereof, so that the polarization state of the light passing through the first optical element 1 is influenced according to the respective pixel-by-pixel selectable orientations of the liquid crystal molecules, wherein the local controllable electric fields are controlled by a drive circuit, and the drive circuit is controlled by digital signals, each of pixels corresponds to a digital signal, and at least a maximal digital signal, a minimal digital signal, and an intermediate digital signal is selected at least at a time point;
under a condition that the liquid crystal layer 3 is arranged in the viewing direction in front of the first optical element 1, a first linear polarization filter X arranged in the viewing direction in front of the liquid crystal layer 3,
so that at the time point, under a condition that the drive circuit is controlled through at least three digital signal, the drive circuit is configured to generate at least three mutually different values, which are a minimal value T2, an intermediate value T3, and a maximal value T1 of the transmittance, at different positions on the switchable light filter 5 for a selectable angle that is the same at each of the different positions on the switchable light filter 5.

Exemplarily, corresponding digital signals can correspond to one of the 256 gray levels, for example, stored in a bitmap file. Optionally, they can be dynamically adjusted. Such digital signals can also be used for the electronic control to generate the first electric field EF1, the second electric field EF2, and the third electric field EF3 in the third embodiment. However, they can also be applied to the first and second embodiments described above, with appropriate modifications for dual-cell panels or other configurations.

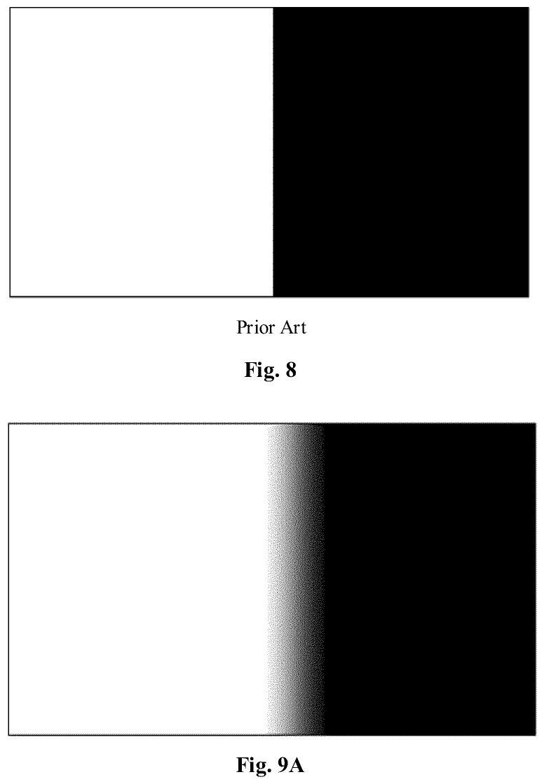

FIG. 8 shows a schematic view for exemplary digital signals each corresponding to one of the 256 gray levels in a bitmap, in the prior art. By using the bitmap shown in FIG. 8 in the fourth embodiment, a clearly visible edge between the left area in operation mode B1 and the right area in operation mode B2 are apparent, as soon as a viewer slightly moves the head (e.g., by a few centimeters).

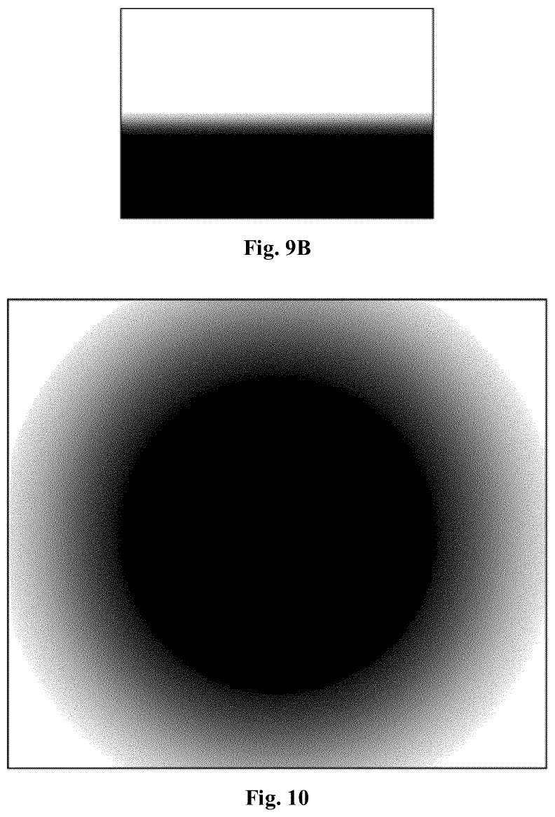

FIG. 9A shows another schematic view for digital signals corresponding to one of the 256 gray levels in a bitmap, wherein a vertical edge between areas of different operation modes is made less visible, when such a bitmap is used in the fourth embodiment.

FIG. 9B shows another schematic view for digital signals corresponding to one of the 256 gray levels, wherein a horizontal edge between areas of different operation modes is made less visible, when such a bitmap is used in the fourth embodiment.

FIG. 10 shows another schematic view for digital signals corresponding to one of the 256 gray levels, wherein the transition between areas of different operation modes is made less visible radially, when such a bitmap is used in the fourth embodiment.

Some other configurations of such bitmaps or digital signals are possible.

Preferably, in any one or more embodiments, at least three mutually different values of the transmittance are generated, for the angle that is the same, at the different positions on the switchable light filter 5 respectively, and the different positions are preferably directly adjacent. That is, the transmission values for a fixed angle decrease or increase along a selectable straight line on the surface of the switchable light filter 5 from maximum to minimum values or vice versa. Thus, a relatively smooth transition of the transmission values from minimum to maximum or vice versa is achieved, because at least the intermediate value of the transmission is spatially lay therebetween.

As described above, more than three transmission values (e.g., five, eight, or more than eight) are desirable to make the aforementioned transition continuous and visually smooth.

In all embodiments described above, the same means-and-effect relationships apply: a location of the maximum transmittance T1 does not immediately follow a local location of the minimum transmittance T2 for a selectable angle, which usually corresponds to the angle α, but can also be chosen differently (for example, when the angle is 45° in a horizontal direction from a viewer's perspective, this location on the switchable light filter 5 is in a privacy mode), but follows at least one location representing the average value T3 of the transmittance under the given angle, or several intermediate values T3 of the transmittance as described.

Generally, “positions” refers to two-dimensional positions, which, if present, on the first optical element 1 and the switchable light filter 5 each indicate the same X-and Y-coordinates on the surface. Therefore, the term “position” can be used with congruent meaning for the optical element 1 and the switchable light filter 5.

The present disclosure solves the problem as follows: a light filter is described, and the light incident in the light filter is transmitted at different positions on the light filter or the screen having such a light filter, or partially or (almost) completely absorbed. To avoid visible edges during partial switching, at least three operation modes B1, B2, B3 must be provided. Specifically, the transmission behavior should be locally switchable for defined angles or directions. In addition, a corresponding screen or a lighting device may be described, whose angle-dependent luminance distribution can be locally changed, and visible edges between areas operating in different modes may also be avoided.

The present disclosure can be used advantageously in combination with a display device wherever confidential data is displayed and/or input, e.g., during the PIN input, for the data display on cash machines or payment terminals, for the password input, or when reading emails on mobile devices. As described further above, the present disclosure can also be used in a passenger car to optionally keep disruptive image contents from the driver or passenger.

1. A switchable light filter, comprising:
a device for selectively influencing an angle-dependent transmittance of the switchable light filter for light incident thereon, wherein
the device for influencing the angle-dependent transmittance is configured to generate, at least at a time point at different positions on the switchable light filter for a selectable angle that is same at each of the different positions on the switchable light filter, at least three mutually different values, which are a minimal value, an intermediate value, and a maximal value of the transmittance, of the transmittance for at least one direction of a hemisphere.

2. The switchable light filter according to claim 1, wherein
the device for influencing the angle-dependent transmittance of the switchable light filter comprises at least a guest-host liquid crystal arrangement having liquid crystal molecules or polymer dispersed liquid crystal (PDLC) having liquid crystal molecules, an orientations of the liquid crystal molecules determining the angle-dependent transmittance of the switchable light filter, and the orientations of the liquid crystal molecules being different at the different positions on the switchable light filter.

3. The switchable light filter according to claim 1, wherein
the device for influencing the angle-dependent transmittance of the switchable light filter is integrated in a dual-cell or multi-cell configuration, the orientations of the liquid crystal molecules in the dual-cell or multi-cell configuration which are responsible for the variable angle-dependent transmittance are different at the different positions on the switchable light filter.

4. The switchable light filter according to claim 1, comprising:
a first optical element comprising:
a plurality of light-absorbing transition dipole moments arranged in a layer having a thickness of at least 0.2 micrometers, wherein in at least a first state, the plurality of light-absorbing transition dipole moments are aligned with a tolerance of maximally 20° parallel to a first preferred direction that is selectable for the first optical element, or fluctuate around the first preferred direction, the first preferred direction being set at a predefined angle α relative to a perpendicular bisector of the first optical element, and the angle α being measured in a selectable first plane including the perpendicular bisector,
so that light incident on the first optical element and having an incidence direction and a polarization state is transmitted therethrough or at least partially absorbed, according to the incidence direction relative to the first optical element and the polarization state thereof;
a device for selectively applying at least one of a first electric field, a second electric field, or a third electric field, wherein the first electric field, the second electric field, and the third electric field are each selectable to be applied to different positions on the switchable light filter in different manners;
a liquid crystal layer arranged behind or in front of the first optical element in a viewing direction, wherein the first electric field, the second electric field, and the third electric field each act on the liquid crystal layer, so that the liquid crystal layer influences, based on the electric field, the polarization state of light passing through it;
a first linear polarization filter, which is disposed in front of the liquid crystal layer in the viewing direction, under a condition that the liquid crystal layer is arranged in front of the first optical element in the viewing direction,
so that a transmission property of the switchable light filter varies at each of the positions for an operation mode B1, in which the first electric field is applied, an operation mode B2, in which the second electric field is applied, and at least an operation mode B3, in which the third electric field is applied, the respective relative transmittances at each of the positions in the operation modes B1, B2, and B3 within a selectable tolerance are described by a first transmittance T_{B1}(ß) for the operation mode B1, a second transmittance T_{B2}(ß) for the operation mode B2, and a third transmittance T_{B3}(ß) for the operation mode B3, and the first transmittance, the second transmittance, and the third transmittance are each dependent on an angle ß, and normalized, so that T_{B1}(α)=1, T_{B2}(α)=1, and T_{B3}(α)=1 hold for the values of the transmittances at the predefined angle α,
wherein
under a condition that light is incident on the first optical element at the angle ß with ß=α−40° or ß=α+40°, at positions in the operation mode B1 in which the first electric field is applied, an s-polarized component of the light is transmitted with at least a normalized first transmittance value T_{B1}(ß)≥0.25,
under the condition that light is incident on the first optical element at the angle ß with ß=α−40° or ß=α+40°, at positions in the operation mode B2 in which the second electric field is applied, a p-polarized component of the light is transmitted with at least a normalized second transmittance value T_{B2}(ß)≤0.2, and
under the condition that light is incident on the first optical element at the angle ß with ß=α−40° or ß=α+40°, at positions in the operation mode B3 in which the third electric field is applied, the light is transmitted with a normalized third transmittance value T_{B2}(ß)<T_{B3}(ß)<T_{B1}(ß).

5. The switchable light filter according to claim 1, comprising:
a first optical element comprising:
a plurality of light-absorbing transition dipole moments arranged in a layer having a thickness of at least 0.2 micrometers, wherein in at least a first state, the plurality of light-absorbing transition dipole moments are aligned with a tolerance of maximally 20° parallel to a first preferred direction that is selectable for the first optical element, or fluctuate around the first preferred direction, the first preferred direction being set at a predefined angle α relative to a perpendicular bisector of the first optical element, and the angle α being measured in a selectable first plane including the perpendicular bisector,
so that light incident on the first optical element is transmitted therethrough or at least partially absorbed, according to an incidence direction thereof relative to the first optical element and a polarization state thereof;
a liquid crystal layer having liquid crystal molecules and arranged behind or in front of the first optical element in a viewing direction, orientations of the liquid crystal molecules being pixel-by-pixel influenced by local controllable electric fields, so that the polarization state of the light passing through the first optical element is influenced according to the respective pixel-by-pixel selectable orientations of the liquid crystal molecules,
wherein the local controllable electric fields are controlled by a drive circuit, and the drive circuit is controlled by a plurality of digital signals which are provided correspondingly for pixels each, and at least one of a maximal digital signal, a minimal digital signal, or an intermediate digital signal between the maximal and the minimal digital signals is selected at least at a time point;
a first linear polarization filter, which is arranged in front of the liquid crystal layer in the viewing direction under a condition that the liquid crystal layer is arranged in the viewing direction in front of the first optical element,
so that at the time point, under a condition that the drive circuit is controlled by the at least three digital signals, at least three mutually different values, which are the minimal value, the intermediate value, and the maximal value of the transmittance, are generated at different positions on the switchable light filter for a selectable angle that is the same for all the different positions on the switchable light filter.

6. The switchable light filter according to claim 1, wherein the at least three mutually different values of the transmittance are generated, for the angle that is the same, at the different positions on the switchable light filter respectively.

7. A lighting device for a screen adapted to operate in at least two operation modes including an operation mode B1 for a free view mode and an operation mode B2 for a limited view mode in which light is emitted within a viewing angle range that is limited for an observer compared to the free view mode, the lighting device comprising:
a backlight extended in a flat manner and configured to emit light; and
the switchable light filter according to claim 1, arranged in front of the backlight in a viewing direction.

8. A screen, comprising:
a display device,
the switchable light filter according to claim 1, arranged behind or in front of the display device in a viewing direction.

9. A screen adapted to operate in at least two operation modes including an operation mode B1 for a free view mode and an operation mode B2 for a limited view mode in which light is emitted within a viewing angle range that is limited for an observer compared to the free view mode, the screen comprising:
a transmissive display device;
a backlight arranged behind the transmissive display device in a viewing direction, wherein the backlight has an asymmetric luminance distribution; and
the switchable light filter according to claim 1, arranged behind or in front of the transmissive display device in a viewing direction,
wherein, in the operation mode B2, the second electric field is applied, and in the operation mode B1, the first electric field is applied.

10. A switchable lighting device adapted to operate in at least two operation modes including an operation mode B1 for a free view mode and an operation mode B2 for a limited view mode in which light is emitted within a viewing angle range that is limited compared to the free view mode, and the switchable lighting device comprising:
a backlight extended in a flat manner and configured to emit light within a limited viewing angle in a first alternative, and to emit light within a non-limited viewing angle range in a second alternative;
a plate-shaped light guide, disposed in front of the backlight in a viewing direction, wherein the plate-shaped light guide has light-exiting elements on at least one of large surfaces and/or inside a volume of the plate-shaped light guide; and
lighting components arranged laterally on at least a narrow side of the light guide,
wherein
in a first alternative, in the operation mode B2, the backlight is turned on and the light mean is turned off, and in the operation mode B1, at least the light mean is turned on,
in a second alternative, in the operation mode B2, the backlight is turned off and the light mean is turned on, and in the operation mode B1, at least the backlight is turned on, and
wherein, under a condition that one or both of the backlight and the light guide emit light, the backlight and/or the light guide generates at least at a time point at different positions on the backlight and/or the light guide for a selectable angle that is same at each of the different positions, at least three mutually different brightness, which are a minimal value, an intermediate value, and a maximal value of the brightness.

11. The switchable lighting device according to claim 10, wherein the at least three mutually different values of the brightness are generated for the angle that is the same at the different positions on the backlight and/or the light guide respectively.

12. A switchable screen, at least comprising:
a display device; and
a device for influencing an angle-dependent brightness of the switchable screen,
wherein the device for influencing the angle-dependent brightness is configured to generate, at least at a time point at different positions on the switchable screen for a selectable angle that is same at each of the different positions on the switchable screen, at least three mutually different values of the brightness, which are a minimal value, an intermediate value, and a maximal value of the brightness.

13. The switchable light filter according to claim 6, wherein the different positions on the switchable light filter are directly adjacent.

14. The switchable lighting device according to claim 11, the different positions are directly adjacent.
